(19) United States
(12) Patent Application Publication
(10) Pub. No.: US 2016/0006916 A1
(43) Pub. Date: Jan. 7, 2016

(54) LENSLESS COMPRESSIVE IMAGE ACQUISITION

(71) Applicant: ALCATEL-LUCENT USA INC., Murray Hill, NJ (US)

(72) Inventors: Hong JIANG, Warren, NJ (US); Gang HUANG, Monroe Twp., NJ (US); Kim MATTHEWS, Warren, NJ (US); Paul WILFORD, Bernardsville, NJ (US)

(21) Appl. No.: 14/609,804

(22) Filed: Jan. 30, 2015

Related U.S. Application Data
(63) Continuation of application No. 13/367,413, filed on Feb. 7, 2012, now abandoned.

(51) Int. Cl. H04N 5/235; H04N 13/02; H04N 5/238; H04N 5/335

(52) U.S. Cl. CPC H04N 5/2353; H04N 5/335; H04N 13/02; H04N 5/238

(57) ABSTRACT

Systems, structures, devices and methods for lensless compressive image acquisition are disclosed herein with which images may be obtained from a single detection element while performing fewer times than a number of pixels associated with the image. Advantageously such systems, structures, devices and methods may be adapted to acquiring images at wavelengths that are difficult or impossible with contemporary CCD or CMOS imagers.

### TECHNICAL FIELD

This disclosure relates generally to image acquisition and more particularly to systems and methods for lensless compressive image acquisition.

### BACKGROUND

Image acquisition—as performed by contemporary digital image or video systems and methods—generally involves the acquisition and immediate compression of large amounts of raw image or video data. Frequently, such systems and methods require expensive sensors and significant computational capabilities.

### SUMMARY

An advance is made in the art according to an aspect of the present disclosure directed to systems, structures, devices and methods for lensless compressive image acquisition.

Viewed from one aspect, the present disclosure is directed to a method for compressive image acquisition including the selective operation of a shutter assembly having an array of individual shutter elements according to a basis, detecting light transmitted through the shutter assembly through the effect of a detector, and making compressive measurements of the detected light. Advantageously, a number of such compressive measurements may be made to produce an image.

Furthermore, images may be obtained with a single detection element while measuring the image far fewer times than the number of pixels associated with contemporary cameras and images they produce. Since—in a preferred representative embodiment only a single detection element is employed—it may advantageously be adapted to images at wavelengths that are difficult or impossible with contemporary CCD or CMOS imagers.

In sharp contrast to the prior art, lensless compressive image acquisition according to aspect of the present disclosure does not employ micromirrors or lenses or a large array of photon detectors such wherein images comprise a number of pixels as with ordinary cameras.

### BRIEF DESCRIPTION OF THE DRAWING

A more complete understanding of the present disclosure may be realized by reference to the accompanying drawings in which:

FIG. 1 depicts a schematic of lensless compressive image acquisition of an object image according to an aspect of the present disclosure;

FIG. 2 depicts a schematic of a lensless compressive image acquisition according to an aspect of the present disclosure;

FIG. 3A depicts an exemplary set of compressive measurements as obtained from a lensless compressive image acquisition system according to an aspect of the present disclosure;

FIG. 3B depicts relationship(s) between LCD element states and values in measurement basis according to an aspect of the present disclosure;

FIG. 4A depicts a schematic of a multi-detector lensless compressive image acquisition according to an aspect of the present disclosure;

FIG. 4B depicts a top view of the multi-detector lensless compressive image acquisition in FIG. 4A;

FIG. 5A depicts a schematic of a multi-detector lensless compressive image acquisition having an array of detectors according to an aspect of the present disclosure;

FIG. 5B depicts a top view of the multi-detector lensless compressive image acquisition system in FIG. 5A;

FIG. 6 depicts a schematic of a multi-detector lensless compressive image acquisition system having an adjustable distance between Liquid Crystal Display (LCD) and plane of detectors according to an aspect of the present disclosure;

FIG. 7A and FIG. 7B schematically show selected features of an example embodiment using multiple detectors for a lensless compressive image acquisition system according to an aspect of the present disclosure;

FIG. 8 depicts a number of pre-determined image acquisition scenarios which determine the shutter sequences for the LCD array according to an aspect of the present disclosure; and

FIG. 9 is a schematic diagram of a representative computer system which may be used to perform operational and control aspects of lensless compressive image acquisition according to an aspect of the present disclosure.

The illustrative embodiments are described more fully by the Figures and detailed description. The inventions may, however, be embodied in various forms and are not limited to embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure. Accordingly, those skilled in the art will readily appreciate the applicability of the present disclosure to a variety of applications.

In the claims hereof any element expressed as a means for performing a specified function is intended to encompass any way of performing that function. This may include, for example, a) electrical or mechanical or optical elements which performs that function or combinations thereof, or b) software in any form, including therefore firmware, microcode or the like combined with appropriate circuitry for executing that software to perform the function, as well as optical and/or mechanical elements coupled to software controlled circuitry, if any. The invention as defined resides in the fact that the functionalities provided by the various recited means are combined and brought together in the manner which the claims call for. Applicants thus regard any means which can provide those functionalities as equivalent as those shown herein.

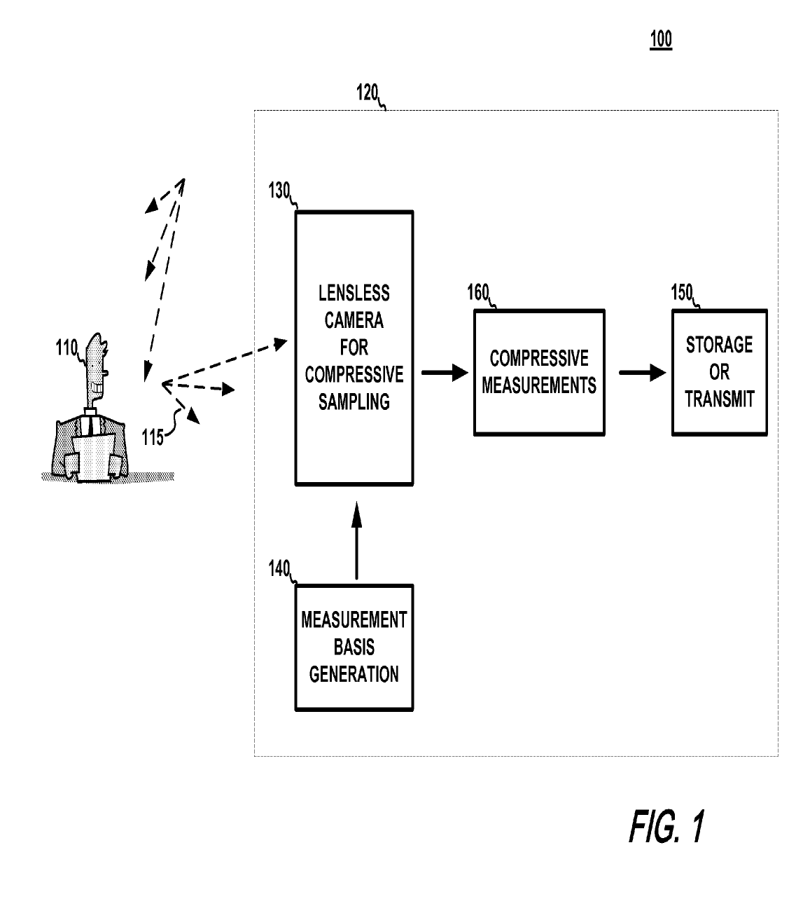

Turning now to FIG. 1 there is shown a schematic diagram depicting lensless compressive image acquisition 100 of an object 110 according to an aspect of the present disclosure. More particularly, incident light 115 reflecting from object 110 is received by lensless camera 130, which provides compressive sampling of the light 115 in accordance with measurement basis generation 140. Compressive measurements 160 of the light are made for subsequent storage and/or transmission 150. Those skilled in the art will appreciate and understand that while these functions are shown separately, they may advantageously be integrated into a single, lensless camera system 120.

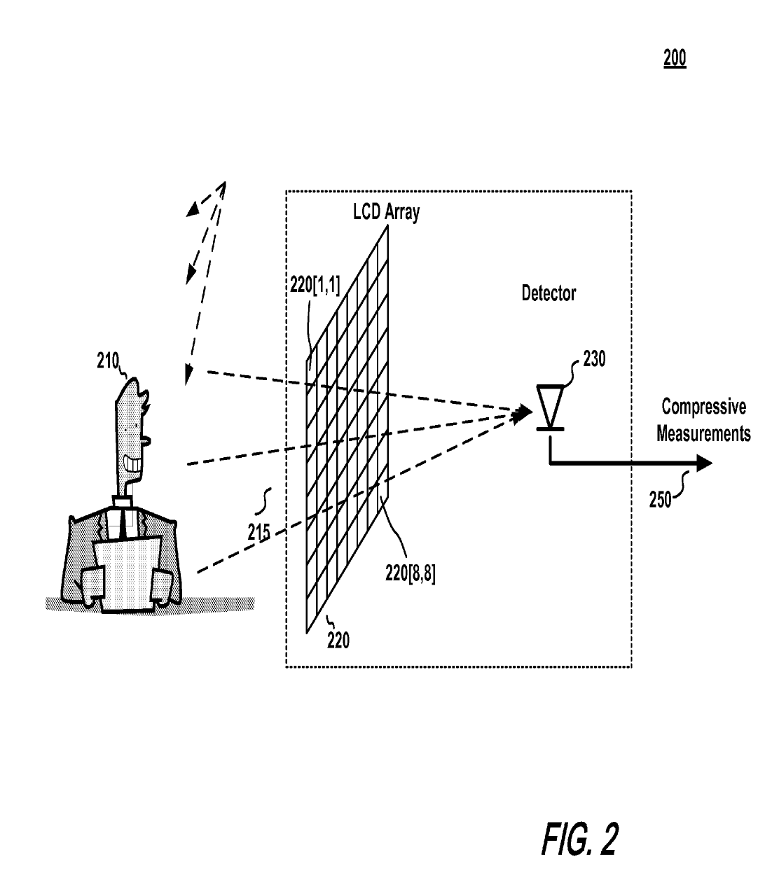

With reference now to FIG. 2, there is shown an exemplary camera 200 which performs lensless compressive image acquisition according to an aspect of the present disclosure. As depicted in this FIG. 2, incident light 215 reflected from object 210 is received by camera 200 where it is selectively permitted to strike detector 230 through the effect of LCD shutter array 220. The detector 230 output is then used to make compressive measurements 250.

As shown further in FIG. 2, the LCD shutter array 220 comprises an array of individual LCD elements or shutters 220[i,j] where—in this example, [i,j] are the indices into the LCD array 220 which identify a particular element.

By way of example only, the shutter array 220 is depicted in FIG. 2 as having 64 individual LCD elements. Accordingly, the first element in the shutter array 220 may be depicted as 220[1,l] and the last element depicted as 220[8,8]. Those skilled in the art will appreciate that advantageously, and according to another aspect of the present disclosure, an array of nearly any size may be employed and this one depicted is shown this size for purposes of this example only.

Additionally, we note that while not explicitly shown in the Figures, light which is reflected from the object 210 is not substantially deflected/refracted or otherwise along its path to the detector(s) 230. That is to say, the shutters comprising the shutter array 220 do not deflect the light, they only permit/deny its passage therethrough.

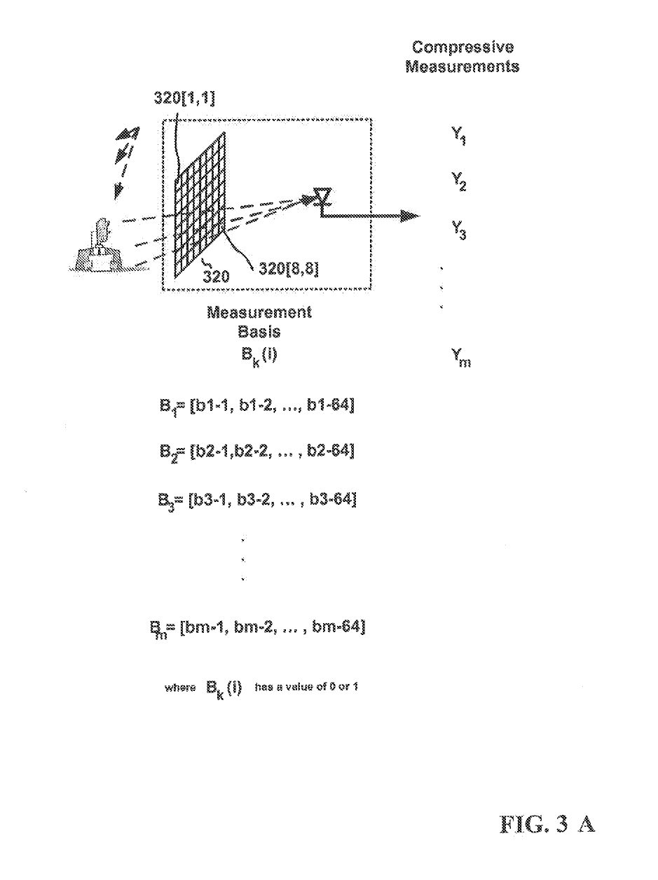

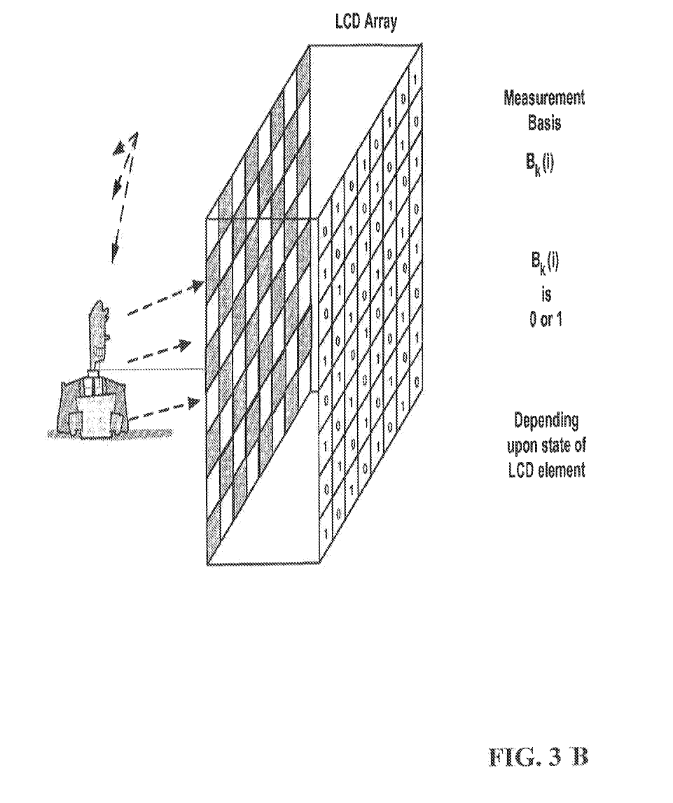

Operationally, a number of compressive measurements 250 are made during a representative image acquisition. Turning now to FIG. 3A, there is shown an exemplary sensor basis B₁ . . . Bm. As depicted in that FIG. 3A and according to an aspect of the present disclosure, the basis is the set of individual values for Bk(i) where i is associated with individual LCD elements in LCD array 320. In this example shown in FIG. 3A, the individual measurement basis B₁, B₂, B₃, . . . , Bm are arrays having the same size as the number of elements in the LCD array 320.

For example, and as noted previously, the example LCD array 320 is an 8×8 array of individual LCD elements for a total of 64 elements. Consequently, an individual measurement, i.e., Bk, will have 64 elements, one for each of the LCD elements in LCD array 320.

As may be further observed from FIG. 3A and FIG. 3B, each individual basis B₁, B₂, B₃, . . . Bm is an array having a size that is the same as the number of individual elements in the LCD array 320. Consequently, each individual element within each measurement basis may be represented as B₁=[bl-1, bl-2, . . . , bl-64], where b 1-1 corresponds to the first element in the LCD array namely 320[1,l] while b 1-64 corresponds to the last element in the LCD array namely 320[8,8]. Similarly, in B₂=[b2-1, b2-2, . . . , b2-64], b2-1 corresponds to the first element in the LCD array namely 320[1,l] while b2-64 corresponds to the last element in the LCD array namely 320[8,8]. Each individual basis Bk produces one compressive measurement Y. A total of m measurements Yi, Y₂, Y₃, . . . Yₘ, are generated by using the set of basis B1, B2, 83, . . . Bm.

Furthermore, each element of the individual basis corresponds to and is indicative of whether or not the particular LCD element was open or closed during a particular acquisition. For example, as depicted in FIG. 3B, the individual array elements in Bk, k=l, . . . , m, have a “1” or a “O” depending upon whether the individual corresponding LCD element is open or closed during a measurement.

In this example shown in FIG. 3A, the first element of Bk, namely, Bk[k-1] corresponds to the first element in LCD array 320, namely 320[1,1]. Likewise, Bk[bm-64] corresponds to the last element in LCD array 320, namely 320[8,8]. Advantageously, and for this particular example, each individual basis, i.e., Bk, may be represented by 64 bits (8 bytes) in contemporary computer systems.

Finally, as shown further in this FIG. 3A, each of the individual compressive measurements Yi, Y₂, Y₃, . . . Ym′ represent the value produced by the detector for a corresponding basis. In that regard, each of the individual compressive measurements may be viewed as the detected sum of each open LCD segment or element during a particular measurement according to a particular basis.

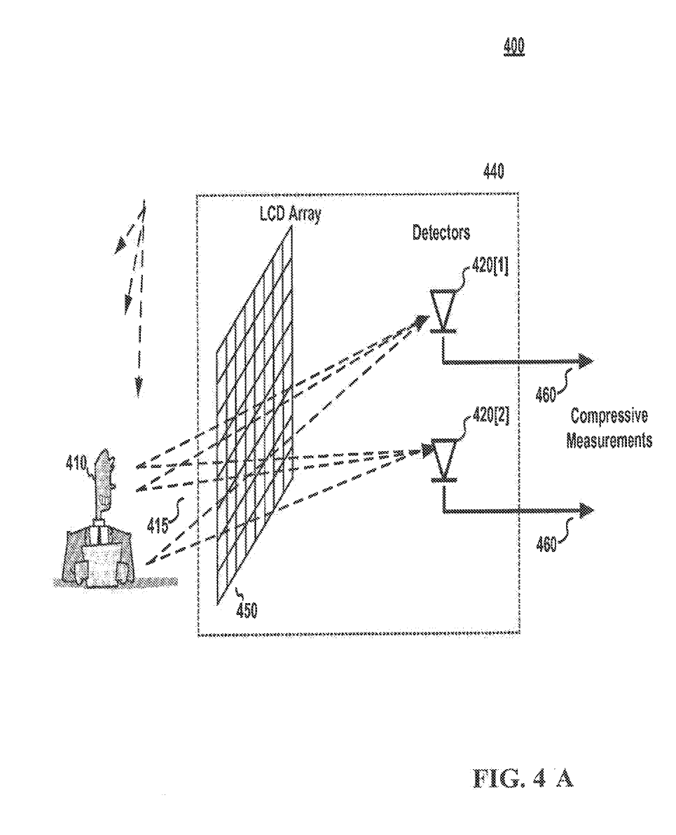

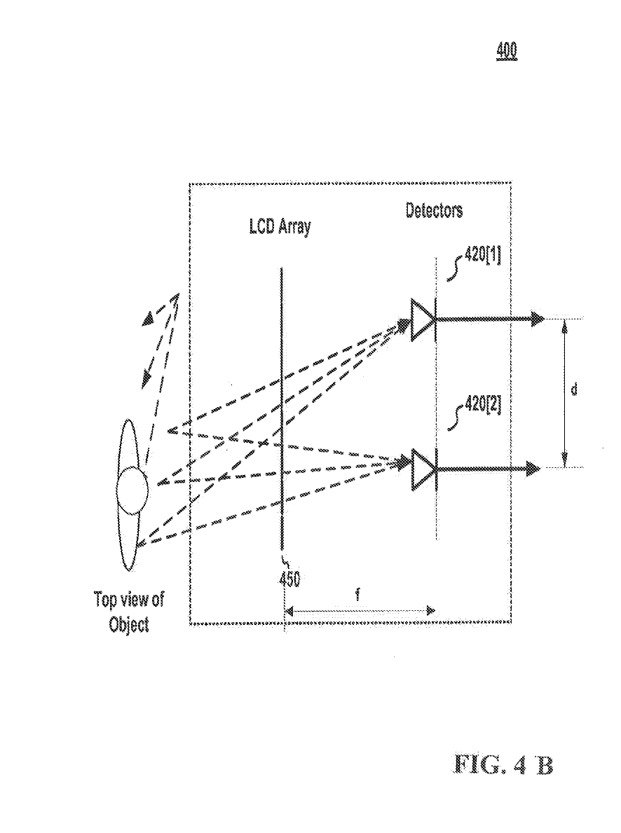

FIG. 4A shows a schematic depiction of a compressive image acquisition system 400 according to yet another aspect of the present disclosure. In this example depicted in FIG. 4A, light reflecting 415 from an object 410 is received by acquisition system 440 wherein it is selectively permitted to strike detectors 420[1], 420[2], through the effect of LCD shutter array 450. The outputs of detectors are used to make compressive measurements 460.

Similar to that shown previously, the LCD shutter array 450 in this FIG. 4A comprises an array of individual LCD elements or shutters 450[i,j] where—in this example, [i,j] are the indices into the LCD array 450 which identify a particular element of the array 450. In this arrangement, two different measurements may be made simultaneously by using one basis Bk. As may be appreciated, this increases the number of individual measurements made within a given time duration.

FIG. 4B is a schematic top view of the arrangement depicted in 4A. More particularly, an object 410 is shown at a front portion of the system 440 including the LCD array 450 and detectors 420[1], 420[2], each positioned a distance f from the LCD array 450 and spaced apart by a distance d. Generally, the detectors 420[1], 420[2], are positioned on a plane parallel to the LCD array 450 on a common horizontal line.

Advantageously, it may be apparent to those skilled in the art that the configuration depicted in FIGS. 4A and 4B provide additional advantageous characteristics not present in the one detector configuration described previously. In particular, each measurement value made by each detector may be for one of two stereo images in a common measurement basis Bk(i). Alternatively, the two measured values may be of the same image, with two different bases Bk(i), and B′k(i) (not specifically shown) representing measurements made by detectors 420[1], and 420[2], respectively.

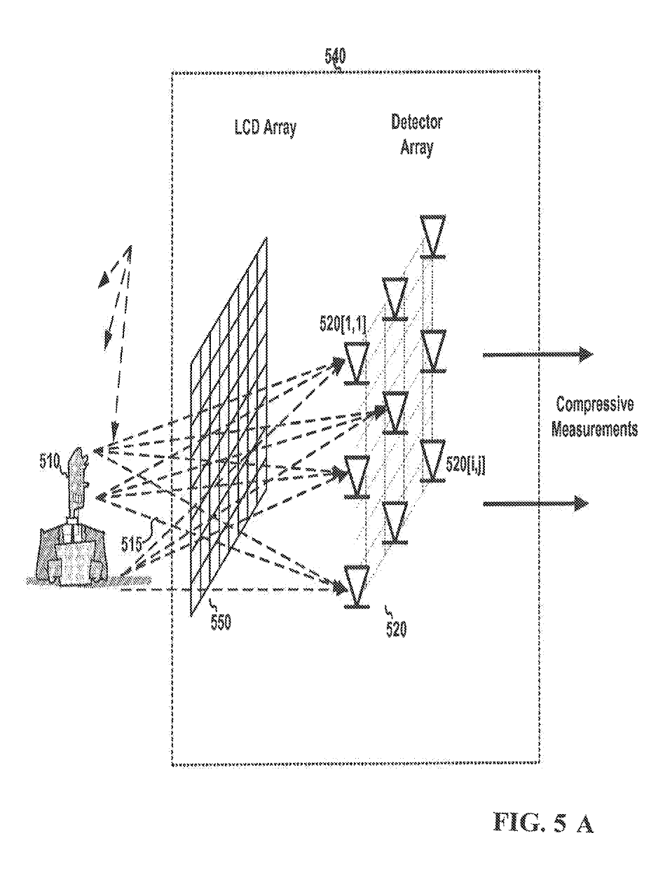

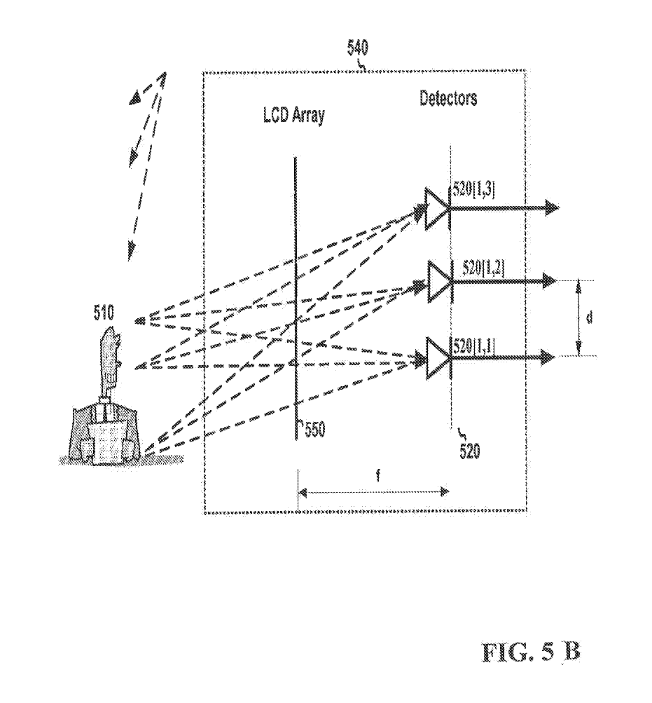

FIG. 5A shows a schematic depiction of a compressive image acquisition system 500 according to yet another aspect of the present disclosure which utilizes an array of detectors. In this example depicted in FIG. 5A, light reflecting 515 from an object 510 is received by acquisition system 540 wherein it is selectively permitted to strike detectors 520[1,l], . . . 520[i,j], through the effect of LCD shutter array 550. The outputs of detectors 520[1,l], . . . 520[i,j] are used to make compressive measurements 560.

FIG. 5B is a schematic top view of the arrangement depicted in 5A. More particularly, and with simultaneous reference to FIG. 5A and FIG. 5B, an object 510 is shown at a front portion of the system 540 including the LCD array 550 and detectors 520[1,l], 520[1,2], . . . 520[i,j], each positioned a distance f from the LCD array 550 and spaced apart by a distance d. Generally, the detectors 520[1,l], 520[1,2], . . . , 520[i,j] are positioned on a plane parallel to the LCD array 550 on a common horizontal line. Note further that while we have used the same indices [i,j] designators for the detector array 520 and the LCD array 550 the indices do not have to be the same size and this disclosure is not so limiting. That is to say, there can be a different number of individual LCD elements in LCD array 530 as compared to the individual detectors in detector array 520.

Similarly to that described previously, each individual detector 520[1,l], 520[1,2], . . . , 520[i,j] in the detector array 520 makes a measurement of a given measurement basis Bk(i). As was the situation before, each measurement may be used for one of a number of images having a particular point of view with respect to the same measurement basis Bk(i). Alternatively, the individual values may serve as multiple measurements of the same image, with different basis B\(i) B²k(i), . . . , BNk(i), where N is the number of individual detectors in the detector array 520

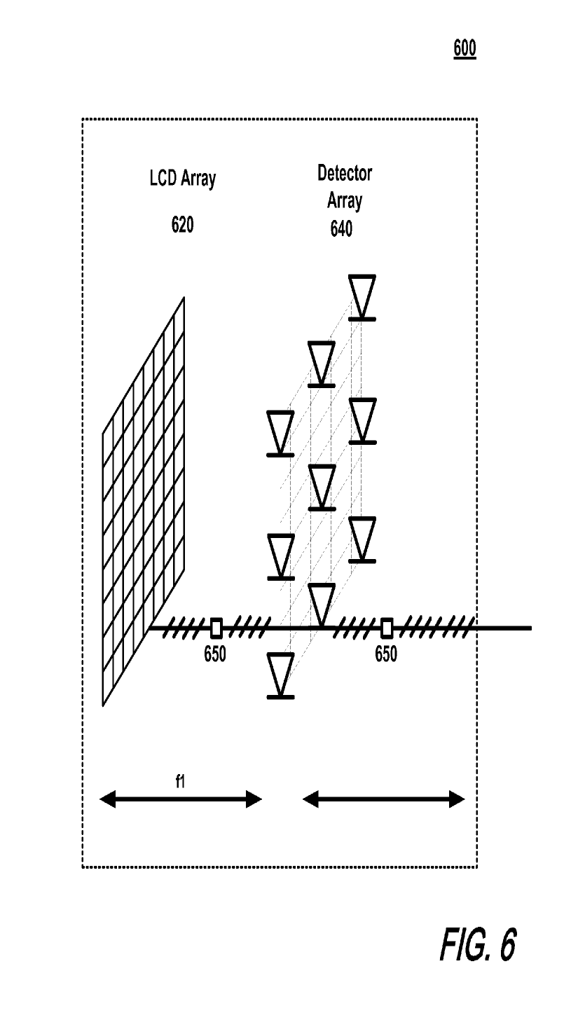

FIG. 6 depicts a schematic of an alternative embodiment of a compressive image acquisition system 600 (lensless camera) according to an aspect of the present disclosure. More particularly, the system 600 exhibits an adjustable distance between LCD array 620 and detector array 640. As shown in this FIG. 6, either the LCD array 620 or detector array 640 may be moved individually or in concert with one another through the use of one or more linear actuators 650 of which any of a variety are known in the art. Notably, the embodiment depicted in this FIG. 6 is not limited to that having an array of detectors 640 such as that shown. Those skilled in the art will appreciate that this embodiment is equally applicable to a single detector configuration or linear array of detector configuration such as those shown and described previously.

Advantageously, the distance between the LCD array and the detector determines the field of view of the image taken by the lensless camera. A shorter distance results in a larger field of view, and a larger distance results in a smaller field of viewer. A desired field of view can be obtained by appropriately adjusting the distance.

As may be further appreciated by those skilled in the art, when a single detector is used in a compressive image acquisition system according to the present disclosure, it is generally the resolution of the LCD array employed which determines the resolution of the overall system. Advantageously, and according to an aspect of the present disclosure, the overall resolution of any images acquired may be increased through the use of multiple detectors with a common LCD array.

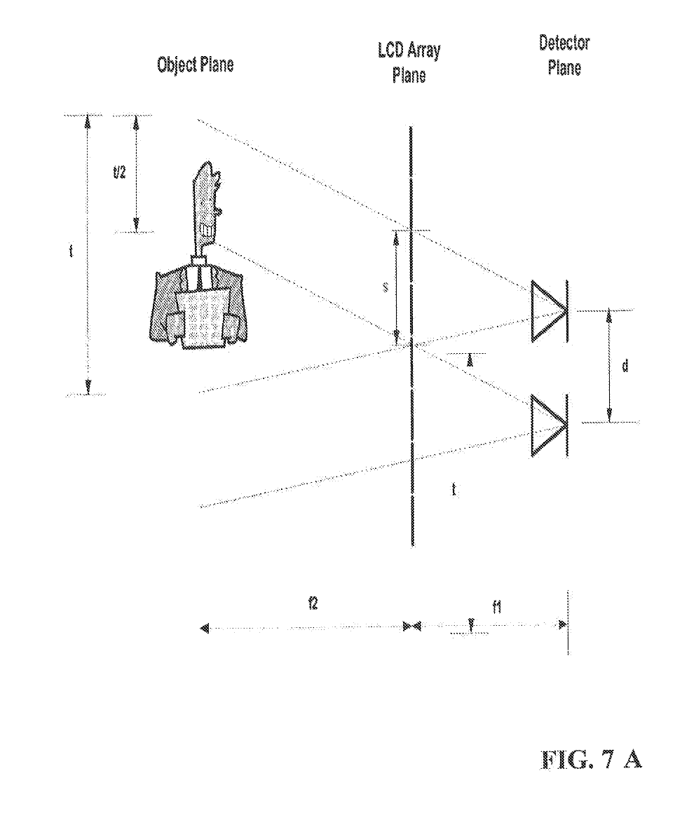

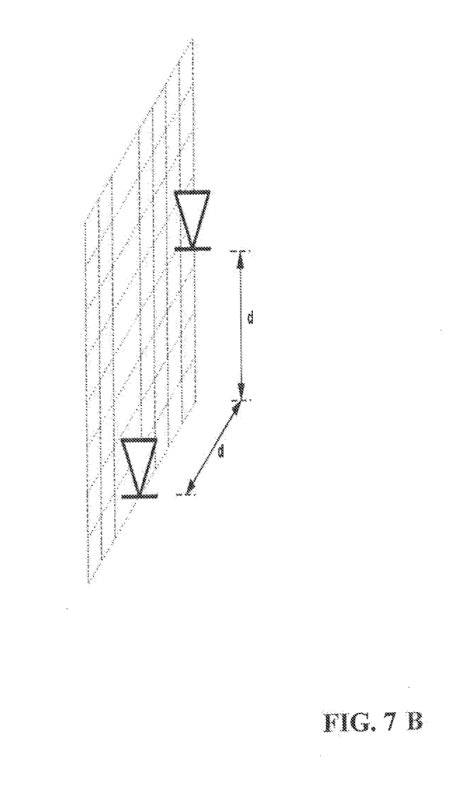

FIGS. 7A and 7B depict the geometric considerations for increasing the resolution of a compressive image acquisition system according to an aspect of the present disclosure wherein a pair of detectors are employed.

Referring to FIG. 7A, two detectors are depicted as being on the same vertical line in a plane parallel to LCD. If d=s (1+f1/f2)/2, then by making a sufficient number of measurements, the resolution of the image at the distance f2 is effectively increased by a factor of 2 in the vertical direction. Referring to FIG. 7B, the resolution increased to 2×2 if the detectors are offset by a distance of d in both vertical and horizontal directions.

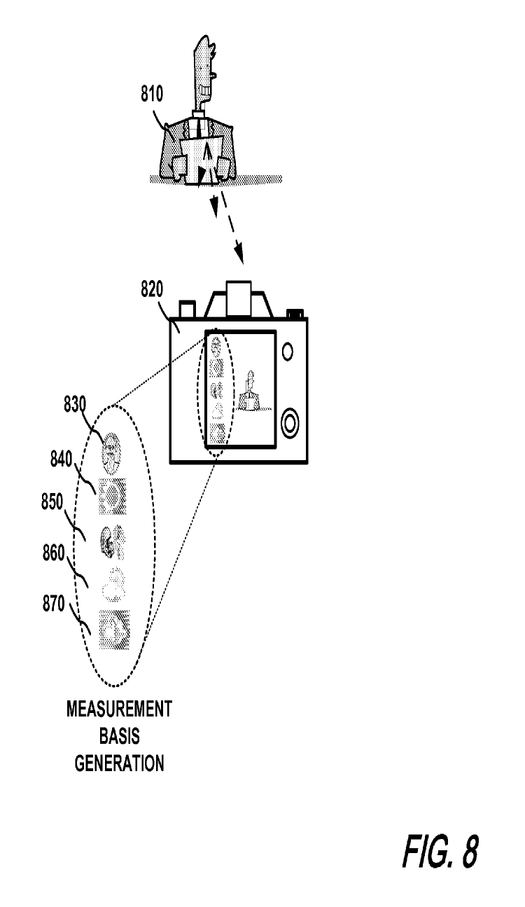

FIG. 8 shows an overall configuration of a lensless compressive image acquisition system according to an aspect of the present disclosure wherein the LCD array within the lensless camera (not specifically shown) are enabled—or not—according to one of a number of pre-determined programming sequences. For example, a “portrait” 830 programming sequence generates a particular acquisition basis that is suitable for a portrait. Similarly, a “bright sunlight” 840 predetermined programming sequence generates a particular basis that is suited to bright sunshine. Similar pre-programmed scenarios may include, for example, a “sports” programming 850, a “partly cloudy” programming 860, and a “cloudy” or “overcast” 870 programming would similarly generate a basis that was suitable to that particular scenario. As was previously noted, a particular basis determines which individual LCD elements are open/closed/Oil for a particular acquisition and overall acquisition sequence.

In this manner, a lensless compressive image acquisition camera according to the present disclosure may be conveniently operated and produce consistent results for a particular application.

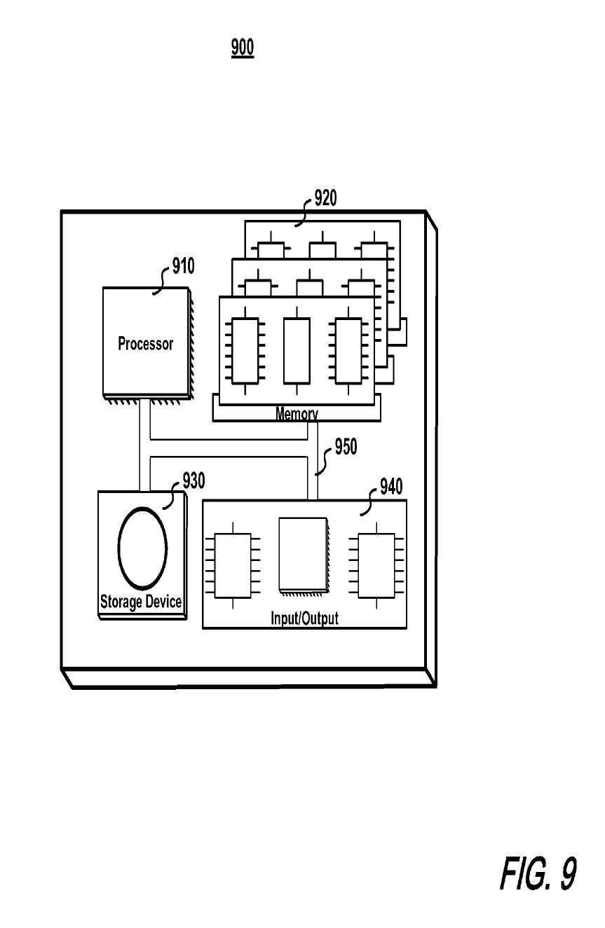

FIG. 9 shows an illustrative computer system 900 suitable for implementing methods and systems according an aspect of the present disclosure. The computer system may comprise, for example a computer running any of a number of known suitable operating systems. The above-described methods of the present disclosure may be implemented on the computer system 900 as stored program control instructions.

Those skilled in the art will readily appreciate that the computer system 900 may be programmed to generate basis, operate the shutter assembly and determine and record compressive measurements. Similarly, it may operate any of a number of actuators for moving the shutter and detector(s), or to store measurements and generate images from the stored measurements.

As depicted, computer system 900 includes processor 910, memory 920, storage device 830, and input/output structure(s) 940. Processor 910 executes instructions m which embodiments of the present disclosure may comprise steps described in conjunction with one or more of the Figures. Such instructions may be stored in memory 920 or storage device 930. Data and/or information may be received an output using one or more input/output devices.

Memory 920 may store data and may be computer-readable medium, such as volatile or non-volatile memory. Storage device 930 may provide storage for system 900 including for example, the previously described steps/methods. In various aspects, storage devices 930 may be a flash memory device, a disk drive, an optical disk device or a tape device employing magnetic, optical, or other recording technologies.

At this point, while we have discussed and described the invention using some specific examples, those skilled in the art will recognize that our teachings are not so limited. Accordingly, the invention should be only limited by the scope of the claims attached hereto.

1. A compressive image acquisition method comprising the steps of:
presenting a plurality of pre-determined programming sequences including at least two of a portrait programming sequence, a sports programming sequence and a lighting condition programming sequence;
selectively operating a shutter assembly having an array of individual shutter elements according to a selected one of the programming sequences;
detecting light transmitted through the operated shutter assembly through the effect of a single detection element; and
generating a compressive measurement of the detected light.

2. The compressive image acquisition method of claim 1 further comprising
the steps of: repeating the selective operation of the shutter assembly, the light detection and
the compressive measurement generation steps such that additional compressive measurements are generated; and
combining the compressive measurement with the additional compressive measurements into an overall compressive measurement.

3. The compressive image acquisition method of claim 2 further comprising
the steps of: generating an image from the overall compressive measurements.

4. The compressive image acquisition method of claim 2 wherein said image generated is of an object from which the transmitted light reflects.

5. The compressive image acquisition method of claim 1 wherein said shutter assembly is an array of liquid crystal display (LCD) elements.

6. The compressive image acquisition method of claim 1 wherein said selected programming sequence comprises an array having a size equal to the number of elements in the shutter assembly, and each element in the array is indicative of the transmissivity of an individual element in the shutter assembly.

7. The compressive image acquisition method of claim 5 wherein the light reflecting from the object is not acted upon by any lenses nor reflected by any mirrors prior to its detection.

8. The compressive image acquisition method of claim 2 further comprising the step of changing a distance between the shutter assembly and the detector such that the resolution of the image is varied.

9. The compressive image acquisition method of claim 1 further comprising
the step of detecting light transmitted through the operated shutter assembly through the
effect of an additional single detection element; and
generating a compressive measurement of the light detected by the additional detection element.

10. The compressive image acquisition method of claim 9 wherein the compressive measurement of the light detected by the detection element and the compressive measurement of the light detected by the additional detection measurement are used to generate a stereo image.

11. (canceled)

12. (canceled)

13. A lensless compressive image acquisition apparatus comprising:
a shutter assembly having an array of individual shutter elements, each individual element selectively operable to allow the passage of light therethrough; and
a first detector element, positioned a distance from the shutter assembly for detecting light passing through the shutter assembly; and
a controller for producing compressive measurements of the detected light;
wherein the lensless compressive imaging acquisition apparatus is used as a camera;
wherein the apparatus presents a user with a plurality of pre-determined sequence choices that are selectable for different types of image acquisition needs, the plurality of pre-determined sequence choices including at least two of a portrait sequence, a sports sequence, and a lighting condition sequence; and
wherein the shutter assembly is controlled based on which of the sequence choices is selected.

14. The lensless compressive image acquisition apparatus of claim 13 wherein the shutter assembly is an LCD array.

15. (canceled)

16. The lensless compressive image acquisition apparatus of claim 13 further comprising a second detector element, positioned at the same distance from the shutter assembly as the first detector element, for detecting light passing through the shutter assembly.

17. (canceled)

18. The lensless compressive image acquisition apparatus of claim 16 wherein output of the first detector element is used to produce a first compressive measurement and output of the second detector element is used to produce a second compressive measurement wherein the first and second compressive measurements are used to produce a stereo image.

19. (canceled)

20. The lensless compressive image acquisition apparatus of claim 16 wherein the first detector element and the second detector element are specific to different wavelengths of light.
